(19) United States
(12) Patent Application Publication
(10) Pub. No.: US 2024/0185646 A1
(43) Pub. Date: Jun. 6, 2024

(54) INTERNATIONAL ROUGHNESS INDEX ESTIMATION METHOD AND SYSTEM

(71) Applicant: Bridgestone Europe NV/SA [BE/BE], Zaventem (BE)

(72) Inventors: Lorenzo Alleva, Roma (IT); Alessandro Boldrini, Roma (IT); Vittorio Nicolosi, Roma (IT); Emiliano Ascenzi, Roma (IT)

(21) Appl. No.: 18/284,947

(22) PCT Filed: Mar. 30, 2022
(86) PCT No.: PCT/EP2022/058405

§ 371 Date: Sep. 29, 2023

(30) Foreign Application Priority Data
Mar. 30, 2021 (IT) 102021000007817

(51) Int. Cl. G07C 5/02; G07C 5/00

(52) U.S. Cl. CPC G07C 5/02; G07C 5/008

(57) ABSTRACT

The invention concerns an International Roughness Index (IRI) estimation method comprising a preliminary step (10) and an IRI estimation step (20), wherein the preliminary step (10) includes: collecting (11) first vehicle vertical acceleration values measured on one or more motor vehicles (40) driven at one or more given constant speeds on one or more roads or road segments associated with known IRI values or known road profiles, first vehicle geo-referencing data of the measured first vertical acceleration values, and first vehicle speed data indicative of the given constant speed(s) associated with the measured first vertical acceleration values; computing (12) first root mean square values of the first vehicle vertical acceleration values: and determining (13), based on the known IRI values/road profiles, on the first vehicle geo-referencing and speed data and on the first root mean square values, one or more vehicle transfer functions mathematically relating vehicle vertical acceleration root mean square values and IRI values at the given constant speed(s). The IRI estimation step (20) includes: acquiring (21) second vehicle vertical acceleration values measured on a given motor vehicle (40) driven at a driving speed on a given road or road segment: computing (22) second root mean square values of the second vehicle vertical acceleration values: and estimating (23) an IRI value for the given road or road segment based on one or more vehicle transfer functions determined in the preliminary step (10) and on the second root mean square values and the driving speed of the given motor vehicle (40).

### TECHNICAL FIELD OF THE INVENTION

The present invention relates, in general, to automotive and road pavement monitoring sectors. More specifically, the present invention concerns a method and a system for International Roughness Index (IRI) estimation.

### STATE OF THE ART

As is known, road pavements need to be designed so as to ensure a rolling surface that is substantially regular and with little deformation in order to meet safety and comfort requirements for motor vehicles driven thereon.

In fact, an impact of a wheel of a motor vehicle against/on an obstacle on the road pavement (such as a pothole or a bump) can cause a damage to the tire of the wheel, in particular to the carcass (i.e., the casing) thereof.

For example, an external bulge on the sidewall of a tire typically indicates that cords have been broken inside the carcass due to an impact against/on an obstacle, since driving on objects like bumps and potholes can cause individual cords to break.

If a damaged tire (e.g., a tire with some damaged cords) is not promptly detected and, hence, is not promptly repaired/replaced, by keeping on driving with said damaged tire there is a risk of completely breaking/destroying the carcass of the tire and even of damaging the wheel rim and/or the suspension (for example, in case of further impacts of the damaged tire against/on other obstacles).

Nowadays, periodical monitoring of regularity/smoothness level of individual roads is carried out from time to time, mainly for the purpose of planning maintenance works. Typically, said monitoring is based on a computation of the International Roughness Index (IRI), which is the roughness index most commonly used for irregularity of road pavements. IRI is typically obtained based on measured longitudinal road profiles (more specifically, longitudinal profiles of elevation of road pavements), in particular by using a quarter-car vehicle mathematical model, whose response is accumulated to yield a roughness index with units of slope (in/mi, m/km, etc.).

Unfortunately, IRI measurements are actually rather expensive and difficult to run on a big scale on the whole road network managed by a company.

Therefore, in the automotive and road pavement monitoring sectors there is markedly felt the need for innovative technical solutions for enabling faster and easier detection of road pavement irregularities/unevenness.

In this connection, WO 2020/225699 A1 discloses a method and a system for recognition of irregularities of a road pavement.

In particular, WO 2020/225699 A1 concerns a method comprising:
a) a preliminary test step including in turn
   a sub-step wherein tests are performed in having pneumatic tires drive over and/or impact different irregularities at different speeds of a motor vehicle,
   a sub-step wherein during the tests the vertical acceleration is acquired (conveniently at a sampling rate of at least 10 Hz), and
   a sub-step for the construction of at least one first model for associating the standard deviation of the vertical acceleration in relation to the tests performed with the irregularities on the road pavement; and
b) an actual recognition step including in turn
   a sub-step wherein the vertical acceleration is acquired (conveniently at a sampling rate of at least 10 Hz),
   a sub-step wherein high-pass filtering of the vertical acceleration is implemented, wherein a minimum filtering threshold of the high-pass filter is preferably less than or equal to 0.1 Hz, and wherein the sub-step of filtering is performed on a reference section of the road pavement of variable length having a length of between 2 and 25 linear meters, preferably between 5 and 10 linear meters,
   a sub-step wherein the vertical acceleration is processed by means of a Fast Fourier Transform (FFT),
   a sub-step wherein the standard deviation of the processed vertical acceleration is calculated by means of an FFT at the relevant t frequencies, wherein the relevant frequencies comprise a first range of vibration frequencies of the motor vehicle suspension system that is preferably between 1.5 Hz and 3 Hz, and
   recognizing the presence and the dimensions of the irregularities on the road pavement on the basis of a comparison between said first model and the standard deviation of the processed vertical acceleration by means of an FFT at the relevant frequencies.

According to WO 2020/225699 A1, the relevant frequencies conveniently comprise a second of vibration range frequencies of the chassis of the motor vehicle, the step b) conveniently comprises the further sub-steps of acquiring information regarding the position of the vehicle by means of a GPS signal, and locating any irregularities depending upon the position of the vehicle, and the step a) conveniently comprises the further sub-steps of performing the tests by means of having different types of tires on different types of motor vehicle drive over and/or impact, and of constructing a number of models in order to associate the standard deviation of the vertical acceleration with the type of tire and/or motor vehicle.

Additionally, according to WO 2020/225699 A1, the step a) preferably includes also:
a sub-step wherein, during the tests performed, the wheel speeds and the speeds of the motor vehicle are acquired and wherein the normalized wheel speeds relating to the tests performed are calculated by means of the ratio between the wheel speeds and the respective speeds of the motor vehicle; and
a sub-step for the construction of at least one second model for associating the standard deviation of the normalized wheel speeds with the irregularities on the road pavement.

Finally, according to WO 2020/225699 A1, the step b) preferably includes:
a sub-step wherein the steering angle of the wheel of said motor vehicle is acquired;
a sub-step wherein the steering angle of the wheel of said motor vehicle is acquired by means of an FFT;
a sub-step wherein a minimum threshold is determined within the frequency content of the steering angle of the wheel processed by means of the FFT;
a sub-step wherein the wheel speeds are acquired;
a sub-step wherein the speeds of the motor vehicle are acquired;
a sub-step wherein the normalized wheel speeds are calculated by means of the ratio between the wheel speeds and the respective speeds of the motor vehicle;
a sub-step wherein high-pass filtering of the wheel speeds or of the normalized wheel speeds is performed in applying said minimum threshold; and
a sub-step wherein the standard deviation of the normalized wheel speeds is calculated;
wherein the sub-step of recognizing the presence of irregularities on the road pavement conveniently implies using both the comparison between the first model and the standard deviation of the processed vertical acceleration by means of an FFT at the relevant frequencies and the comparison between the second model and the standard deviation of the normalized wheel speeds.

### OBJECT AND SUMMARY OF THE INVENTION

In view of the foregoing, the Applicant has felt the need to carry out an in-depth study in order to try developing an innovative technical solution for enabling, in general, faster and easier quantification of roughness of road pavements and, in particular, an IRI-like estimation, which are easier to perform and can be carried out more frequently than traditional IRI measurements, thereby arriving at the present invention.

Thence, object of the present invention is that of providing a technical solution for implementing, in general, a faster and easier quantification of roughness of road pavements and, in particular, an IRI-like estimation, which are easier to perform and can be carried out more frequently than traditional IRI measurements.

This and other objects are achieved by the present invention in that it relates to a method and a system for International Roughness Index (IRI) estimation, as defined in the appended claims.

In particular, an IRI estimation method according to the present invention comprises a preliminary step and an IRI estimation step, wherein the preliminary step includes:
collecting
   first vehicle vertical acceleration values measured on one or more motor vehicles driven at one or more given constant speeds on one or more roads or road segments associated with known IRI values or known road profiles,
   first vehicle geo-referencing data of the measured first vertical acceleration values, and
   first vehicle speed data indicative of the given constant speed (s) associated with the measured first vertical acceleration values;
computing first root mean square values of the first vehicle vertical acceleration values; and
determining, based on the known IRI values/road profiles, on the first vehicle geo-referencing and speed data and on the first root mean square values, one or more vehicle transfer functions mathematically relating vehicle vertical acceleration root mean square values and IRI values at the given constant speed (s).

The IRI estimation step includes:
acquiring second vehicle vertical acceleration values measured on a given motor vehicle driven at a driving speed on a given road or road segment;
computing second root mean square values of the second vehicle vertical acceleration values; and
estimating an IRI value for the given road or road segment based on one or more vehicle transfer functions determined in the preliminary step and on the second root mean square values and the driving speed of the given motor vehicle.

### BRIEF DESCRIPTION OF THE DRAWINGS

For a better understanding of the present invention, preferred embodiments, which are intended purely by way of non-limiting examples, will now be described with reference to the attached drawings (all not to scale), where:

FIGS. 1 and 2 schematically and respectively illustrate a preliminary step and an IRI estimation step of an IRI estimation method according to a preferred embodiment of the present invention;

FIG. 3 shows examples of IRI values related to different segments of a road;

FIG. 4 shows examples of IRI values and root mean square of vehicle vertical accelerations at different vehicle speed;

FIG. 5 shows an example of vehicle transfer function;

FIG. 6 shows an example of comparison between real IRI values of a road or road segment, and IRI values estimated by carrying out the present invention;

FIG. 7 schematically illustrates an IRI estimation system according to a preferred embodiment of the present invention; and

FIGS. 8 and 9 schematically illustrate two preferred embodiments for implementing processing means of the IRI estimation system of FIG. 7.

### DETAILED DESCRIPTION OF PREFERRED EMBODIMENTS OF THE INVENTION

The following discussion is presented to enable a person skilled in the art to make and use the invention. Various modifications to the embodiments will be readily apparent to those skilled in the art, without departing from the scope of the present invention as claimed. Thence, the present invention is not intended to be limited to the embodiments shown and described, but is to be accorded the widest scope of protection consistent with the features defined in the appended claims.

The present invention concerns an International Roughness Index (IRI) estimation method including a preliminary step and an IRI estimation step.

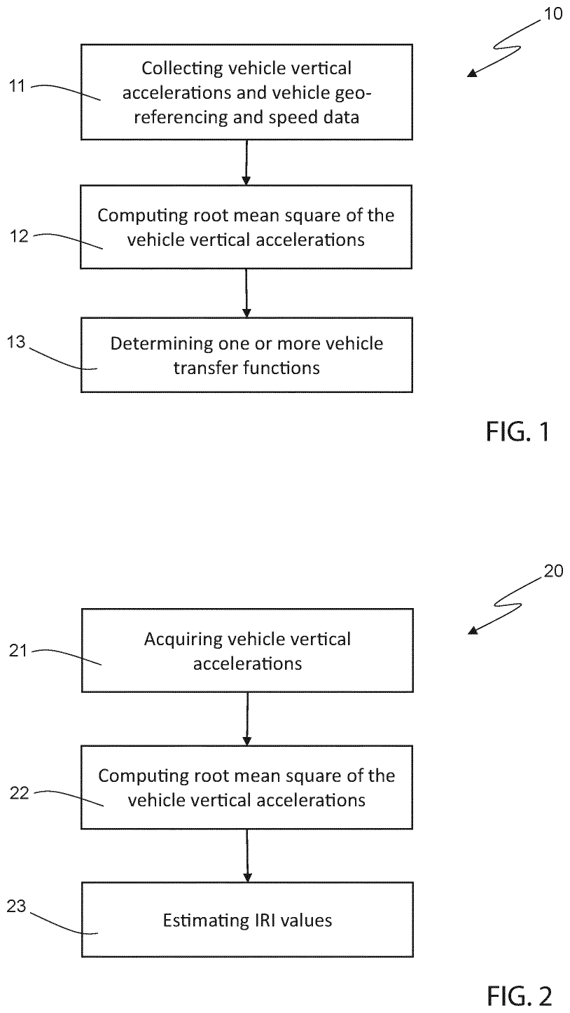

In this respect, FIG. 1 schematically illustrates a preliminary step (denoted as a whole by 10) of an IRI estimation method according to a preferred embodiment of the present invention.

In particular, the preliminary step 10 comprises:
collecting (block 11 in FIG. 1)
   first vehicle vertical acceleration values measured on one or more motor vehicles (such as one or more cars and/or buses and/or trucks and/or motorbikes, etc., fitted with internal combustion engines and/or of the hybrid and/or electric type (s)) driven at one or more given constant speeds on one or more roads or road segments associated with known IRI values or known road profiles,
   first vehicle geo-referencing data of the measured first vertical acceleration values (i.e., data indicative of two/three-dimensional (2D/3D) positions over time corresponding to the measured first vertical acceleration values—e.g., positions provided by Global Navigation Satellite System (GNSS) receivers, such as Global Positioning System (GPS) positions), and
   first vehicle speed data indicative of the given constant speed (s) associated with the measured first vertical acceleration values;
computing (block 12 in FIG. 1) first root mean square values of the first vehicle vertical acceleration values; and
determining (block 13 in FIG. 1), based on the known IRI values/road profiles, on the first vehicle geo-referencing and speed data and on the first root mean square values, one or more vehicle transfer functions mathematically relating vehicle vertical acceleration root mean square values and IRI values at the given constant speed (s).

FIG. 2 schematically illustrates an IRI estimation step (denoted as a whole by 20) of an IRI estimation method according to a preferred embodiment of the present invention.

In particular, the IRI estimation step 20 comprises:
acquiring (block 21 in FIG. 2) second vehicle vertical acceleration values measured on a given motor vehicle driven at a driving speed on a given road/road segment;
computing (block 22 in FIG. 2) second root mean square values of the second vehicle vertical acceleration values; and
estimating an IRI value (block 23 in FIG. 2) for the given road/road segment based on one or more vehicle transfer functions determined in the preliminary step 10 and on the second root mean square values and the driving speed of the given motor vehicle.

Conveniently, IRI estimation step 20 includes acquiring (block 21 in FIG. 2) the second vehicle vertical acceleration values along with second vehicle geo-referencing data of the given motor vehicle (namely, data indicative of 2D/3D position (e.g., GPS position) of the given motor vehicle) and second vehicle speed data indicative of the driving speed of said given motor vehicle.

Preferably, in order to achieve more accurate IRI estimates in the IRI estimation step 20, the preliminary step 10 comprises driving one or more motor vehicles of one and the same given vehicle type and/or of one and the same given vehicle model at one or more given constant speeds on one or more roads or road segments associated with known IRI values or known road profiles, so as to:
collect (block 11 in FIG. 1) first vehicle vertical acceleration values, first vehicle geo-referencing data and first vehicle speed data related to said given vehicle type and/or model; and
determine (block 13 in FIG. 1) one or more vehicle transfer functions specific to said given vehicle type and/or model.

Conveniently, the preliminary step 10 comprises driving one or more motor vehicles of different given vehicle types and/or of different given vehicle models, so as to:
collect (block 11 in FIG. 1) respective first vehicle vertical acceleration values, respective first vehicle geo-referencing data and respective first vehicle speed data for each of said given vehicle types and/or models (conveniently clustering single vehicle type/model passages at constant speed on single roads or road segments with known IRI/profile); and
determine (block 13 in FIG. 1), for each of said given vehicle types and/or models, one or more respective vehicle transfer functions specific to said given vehicle type and/or model.

Accordingly, in the IRI estimation step 20, the IRI value is conveniently estimated (block 23 in FIG. 2) by using at least one vehicle transfer function specific to vehicle type/model of the given motor vehicle determined in the preliminary step 10.

More in detail, in the preliminary step 10, the sub-step of collecting (block 11 in FIG. 1) first vehicle vertical acceleration values, first vehicle geo-referencing data and first vehicle speed data can conveniently include a vehicle telemetry data acquisition, wherein vehicles are conveniently equipped with a data logger unit acquiring vertical accelerations VA and GPS positions GPS of the vehicles with predefined acquisition frequencies f(VA)≥ 10 Hz and f(GPS)≥ 1 Hz, and wherein the telemetry data are automatically transmitted to a remote computing system (e.g., a cloud computing system) via a wireless connection (e.g., based on 2G, 3G, 4G or 5G cellular technology).

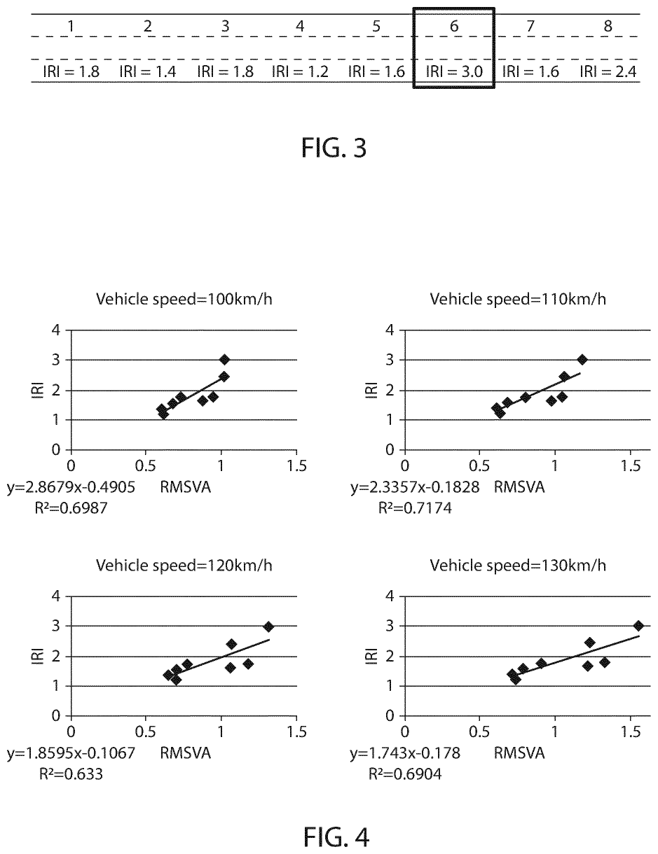

Conveniently, in the preliminary step 10, IRI values related to a road are divided in, and associated with, different road segments, wherein said IRI values are provided by external entities measuring the IRI values through standardized and compliant measuring procedures. In this respect, FIG. 3 shows an example of eight IRI values of a road divided in, and associated with, eight different segments of said road.

Additionally, a predefined time period (e.g., of three months) can be conveniently considered for the vehicle telemetry data acquisition, wherein said predefined time period preferably includes the date of measurement of the IRI values.

Conveniently, the preliminary step 10 further comprises selecting vehicle “good” passages on the road segments at given speed range, wherein the vehicle passages can be conveniently considered to be “good” and, hence, are used for further processing if a vehicle drives on a road segment at constant speed for a minimum of 70% of the road segment length.

Conveniently, GPS is used for positioning the vehicles on the road segments.

Preferably, VA values measured during a passage are processed, root mean square RMSVA_{V} is calculated (block 12 in FIG. 1) and an average RMSVA=average(RMSVA_{V}) is conveniently performed for each road segment by considering the following:
for each one of the involved vehicles,
different moments during the predefined time period,
on a single road segment,
at a given speed.

RMSVA can be conveniently plotted along with known IRI values of the road segments, thereby enabling identification of a related mathematical correlation, whereby a vehicle transfer function IRI=F(RMSVA,speed) can be conveniently determined (block 13 in FIG. 1). In this respect, FIG. 4 shows examples of IRI−RMSVA graphs at different constant vehicle speeds.

Then, in the IRI estimation step 20, an inverse calculation can be conveniently carried out. In fact, once the vehicle transfer function, the RMSVA and the driving speed v of a given vehicle on a generic road are known, it is possible to calculate an estimated IRI value (block 23 in FIG. 2).

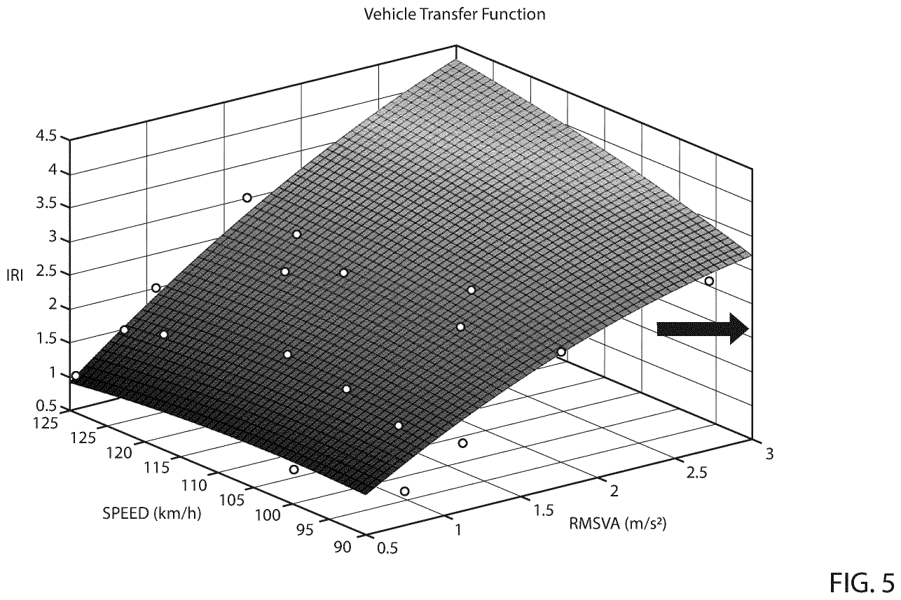

In this respect, FIG. 5 shows an example of vehicle transfer function, namely:

IRI=−1.834−v(km/h)·0.4145+0.04853·RMSVA(m/s²)−0.1925·v²(km/h)−0.0002679 RMSVA²(m/s²)+0.01239·v(km/h)·RMSVA(m/s²).

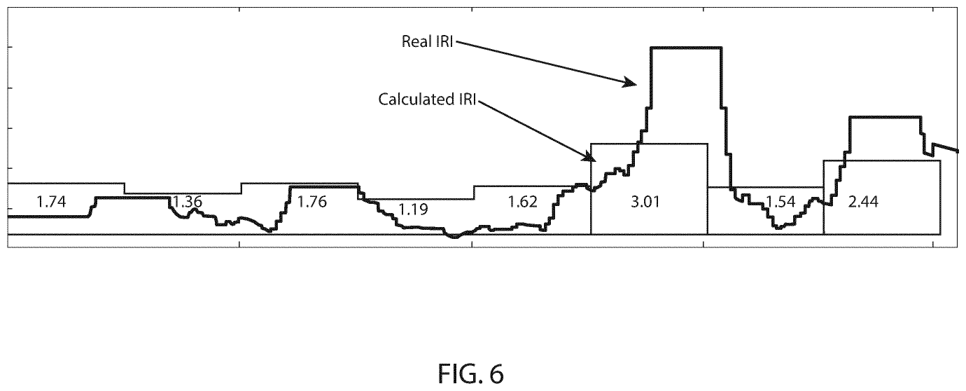

Additionally, FIG. 6 shows an example of comparison between real IRI values of a road or road segment, and IRI values estimated by carrying out the IRI estimation method according to the present invention.

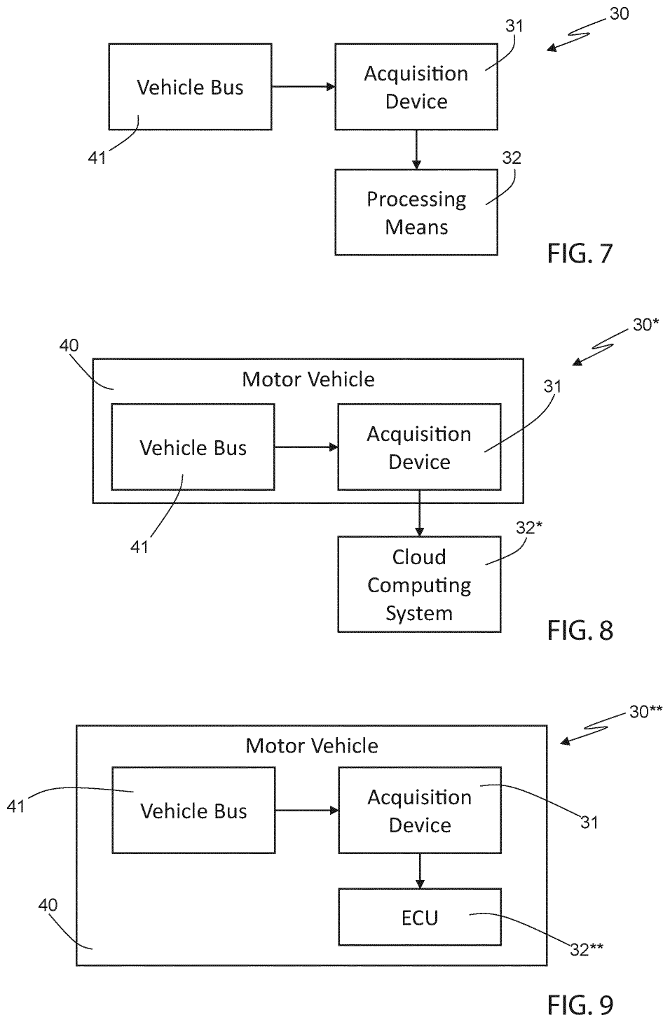

The present invention concerns also a system designed to carry out the above IRI estimation method. In this respect, FIG. 7 schematically illustrates, by means of a block diagram, a functional architecture of an IRI estimation system 30 according to a preferred embodiment of the present invention.

In particular, the IRI estimation system 30 includes an acquisition device 31 that is:
installed on board a motor vehicle (not shown in FIG. 7), such as a car or bus or truck or motorbike, etc., that is fitted with an internal combustion engine or of the hybrid/electric type;
coupled to a vehicle bus 41 (e.g. based upon a standard Controller Area Network (CAN) bus) of said motor vehicle; and
configured to acquire, from said vehicle bus 41, vehicle vertical accelerations and vehicle geo-referencing and speed data.

Preferably, a respective acquisition device 31 is installed on board:
each motor vehicle used to carry out the preliminary step 10 to acquire, from a respective vehicle bus 41 of said motor vehicle, the first vehicle vertical acceleration values and the first vehicle geo-referencing and speed data; and
each given motor vehicle involved in the IRI estimation step 20 to acquire, from a respective vehicle bus 41 of said given motor vehicle, the second vehicle vertical acceleration values and the second vehicle geo-referencing and speed data.

Additionally, the IRI estimation system 30 further includes processing means 32 connected, in a wired or wireless fashion, to the acquisition device (s) 31 to receive therefrom the first/second vehicle vertical acceleration values and the first/second vehicle geo-referencing and speed data, and programmed to:
compute (block 12 in FIG. 1) the first root mean square values and determine (block 13 in FIG. 1) the vehicle transfer function (s); and
compute (block 22 in FIG. 2) the second root mean square values and estimate the IRI value(s) (block 23 in FIG. 2).

FIGS. 8 and 9 schematically illustrate two preferred embodiments for implementing the processing means 32.

In particular, with reference to FIG. 8, in a first preferred embodiment (denoted as a whole by 30*), the processing means 32 are implemented/carried out by means of a cloud computing system 32* that is wirelessly and remotely connected to the acquisition device (s) 31 (e.g., via one or more cellular technologies, such as GSM, GPRS, EDGE, HSPA, UMTS, LTE, LTE Advanced, 5G, etc.), and that is conveniently used to perform both the preliminary step 10 and the IRI estimation step 20.

Instead, with reference to FIG. 9, in a second preferred embodiment (denoted as a whole by 30**), the processing means 32 are implemented/carried out by means of an (automotive) Electronic Control Unit (ECU) 32** installed on board a motor vehicle 40, wherein said ECU 32** may conveniently be an ECU specifically dedicated to IRI estimation, or an ECU dedicated to several tasks including also IRI estimation.

Preferably, the cloud computing system 32* is used to carry out the preliminary step 10, whereas the ECU 32** is used to perform the IRI estimation step 20. In particular, a respective ECU 32** can be conveniently installed on board each given motor vehicle 4 involved in the IRI estimation step 20 to acquire, from the respective acquisition device 31, the second vehicle vertical acceleration values and the second vehicle geo-referencing and speed data.

From the foregoing, the technical advantages and the innovative features of the present invention are immediately clear to those skilled in the art.

In particular, it is important to point out that the present invention allows implementing, in general, a faster and easier quantification of roughness of road pavements and, in particular, an IRI-like estimation, which are easier to perform and can be carried out more frequently than traditional IRI measurements. More specifically, the IRI estimation method and system according to the present invention allow providing road network managing companies with rough (i.e., less accurate) but cheaper, more capillary and more frequent IRI estimates thereby enabling a cheaper, more capillary and more frequent road pavement monitoring.

As previously explained, the present invention allows estimating IRI values by exploiting vertical accelerations of vehicles belonging to a connected fleet. In particular, the IRI estimation method and system according to the present invention allow using connected vehicles' vertical accelerations at constant speed to determine rough IRI values for the driven roads with a frequency higher than the conventional IRI measurement methods. The IRI estimates, albeit less accurate, are nevertheless useful for achieving a cheaper, more capillary and more frequent road pavement monitoring, thereby enabling road network managing companies to prioritize more accurate IRI measurements for specific roads or road segments, and to appropriately plan and/or prioritize maintenance works thereon.

In conclusion, it is clear that numerous modifications and variants can be made to the present invention, which fall within the scope of the invention as defined in the appended claims.

1-12. (canceled)

13. An international roughness index estimation method comprising:
in a preliminary stage, collecting:
first vertical acceleration values measured on one or more motor vehicles driven at one or more given constant speeds on one or more roads or road segments associated with known international roughness index values or known road profiles;
first vehicle geo-referencing data of the measured first vertical acceleration values; and
first vehicle speed data indicative of the one or more given constant speeds associated with the measured first vertical acceleration values;
further in the preliminary stage:
computing first root mean square values of the first vertical acceleration values;
determining one or more vehicle transfer functions mathematically relating vehicle vertical acceleration root mean square values and international roughness index values at the one or more given constant speeds, based on the known international roughness index values or road profiles, the first vehicle geo-referencing data, the first vehicle speed data, and the first root mean square values; and
in an international roughness index estimation stage:
acquiring second vertical acceleration values measured on a given motor vehicle driven at a driving speed on a given road or road segment;
computing second root mean square values of the second vertical acceleration values; and
estimating an international roughness index value for the given road or road segment based on one or more vehicle transfer functions determined in the preliminary stage and on the second root mean square values and the driving speed of the given motor vehicle.

14. The method of claim 13, wherein the international roughness index estimation stage includes acquiring the second vertical acceleration values along with second vehicle geo-referencing data of the given motor vehicle and second vehicle speed data indicative of the driving speed of the given motor vehicle.

15. The method of claim 13, wherein the preliminary stage comprises:
driving one or more motor vehicles of one and the same given vehicle type and/or of one and the same given vehicle model at one or more given constant speeds on one or more roads or road segments associated with known international roughness index values or known road profiles;
collecting first vertical acceleration values, first vehicle geo-referencing data, and first vehicle speed data related to the given vehicle type and/or model; and
determining one or more vehicle transfer functions specific to the given vehicle type and/or model.

16. The method of claim 13, wherein the preliminary stage comprises:
driving one or more motor vehicles of different given vehicle types and/or of different given vehicle models at one or more given constant speeds on one or more roads or road segments associated with known international roughness index values or known road profiles;
collecting respective first vehicle vertical acceleration values, respective first vehicle geo-referencing data, and respective first vehicle speed data for each of the given vehicle types and/or models; and
for each of the given vehicle types and/or models, determining one or more respective vehicle transfer functions specific thereto;
wherein, in the international roughness index estimation stage, the international roughness index value is estimated by using at least one vehicle transfer function specific to vehicle type/model of the given motor vehicle determined in the preliminary stage.

17. The method of claim 13, wherein in the preliminary stage:
one or more average values of the first root mean square values are computed; and
the one or more vehicle transfer functions are determined based on the one or more computed average values.

18. An international roughness index estimation system comprising:
for each of one or more motor vehicles, first and second acquisition devices coupled to a respective vehicle bus of the motor vehicle;
a cloud computing system remotely coupled to the first and second acquisition devices for each of the one or more motor vehicles and configured, in a preliminary stage, to receive from the respective one or more first acquisition devices:
first vertical acceleration values wherein the respective motor vehicle is driven at one or more given constant speeds on one or more roads or road segments associated with known international roughness index values or known road profiles;
first vehicle geo-referencing data of the measured first vertical acceleration values; and
first vehicle speed data indicative of the one or more given constant speeds associated with the measured first vertical acceleration values;
the cloud computing system further configured in the preliminary stage to:
compute first root mean square values of the first vertical acceleration values;
determine one or more vehicle transfer functions mathematically relating vehicle vertical acceleration root mean square values and international roughness index values at the one or more given constant speeds, based on the known international roughness index values or road profiles, the first vehicle geo-referencing data, the first vehicle speed data, and the first root mean square values; and
the cloud computing system further configured in an international roughness index estimation stage to:
acquire, from the respective one or more second acquisition devices, second vertical acceleration values measured on a given motor vehicle driven at a driving speed on a given road or road segment;
compute second root mean square values of the second vertical acceleration values; and
estimate an international roughness index value for the given road or road segment based on one or more vehicle transfer functions determined in the preliminary stage and on the second root mean square values and the driving speed of the given motor vehicle.

19. The system of claim 18, wherein the cloud computing system is configured in the international roughness index estimation stage to acquire the second vertical acceleration values along with second vehicle geo-referencing data of the given motor vehicle and second vehicle speed data indicative of the driving speed of the given motor vehicle.

20. The system of claim 18, wherein the preliminary stage comprises:
driving one or more motor vehicles of one and the same given vehicle type and/or of one and the same given vehicle model at one or more given constant speeds on one or more roads or road segments associated with known international roughness index values or known road profiles;
collecting first vertical acceleration values, first vehicle geo-referencing data, and first vehicle speed data related to the given vehicle type and/or model; and
determining one or more vehicle transfer functions specific to the given vehicle type and/or model.

21. The system of claim 18, wherein the preliminary stage comprises:
driving one or more motor vehicles of different given vehicle types and/or of different given vehicle models at one or more given constant speeds on one or more roads or road segments associated with known international roughness index values or known road profiles;
collecting respective first vehicle vertical acceleration values, respective first vehicle geo-referencing data, and respective first vehicle speed data for each of the given vehicle types and/or models; and
for each of the given vehicle types and/or models, determining one or more respective vehicle transfer functions specific thereto;
wherein, in the international roughness index estimation stage, the international roughness index value is estimated by using at least one vehicle transfer function specific to vehicle type/model of the given motor vehicle determined in the preliminary stage.

22. The system of claim 18, wherein in the preliminary stage:
one or more average values of the first root mean square values are computed; and
the one or more vehicle transfer functions are determined based on the one or more computed average values.

23. An international roughness index estimation system comprising:
for each of one or more motor vehicles, first and second acquisition devices coupled to a respective vehicle bus of the motor vehicle;
a cloud computing system remotely coupled to the first acquisition device for each of the one or more motor vehicles and configured, in a preliminary stage, to receive therefrom:
first vertical acceleration values wherein the respective motor vehicle is driven at one or more given constant speeds on one or more roads or road segments associated with known international roughness index values or known road profiles;
first vehicle geo-referencing data of the measured first vertical acceleration values; and
first vehicle speed data indicative of the one or more given constant speeds associated with the measured first vertical acceleration values;
the cloud computing system further configured in the preliminary stage to:
compute first root mean square values of the first vertical acceleration values; and
determine one or more vehicle transfer functions mathematically relating vehicle vertical acceleration root mean square values and international roughness index values at the one or more given constant speeds, based on the known international roughness index values or road profiles, the first vehicle geo-referencing data, the first vehicle speed data, and the first root mean square values; and
for each of the one or more motor vehicles, a respective electronic control unit installed onboard the motor vehicle and coupled to the respective second acquisition device, and configured in an international roughness index estimation stage to:
acquire, from the respective second acquisition device, second vertical acceleration values measured on the respective motor vehicle driven at a driving speed on a given road or road segment;
compute second root mean square values of the second vertical acceleration values; and
estimate an international roughness index value for the given road or road segment based on one or more vehicle transfer functions determined in the preliminary stage and on the second root mean square values and the driving speed of the respective motor vehicle.

24. The system of claim 23, wherein each of the respective electronic control units are configured in the international roughness index estimation stage to acquire the second vertical acceleration values along with second vehicle geo-referencing data of the respective motor vehicle and second vehicle speed data indicative of the driving speed of the respective motor vehicle.

25. The system of claim 23, wherein the preliminary stage comprises:
driving one or more motor vehicles of one and the same given vehicle type and/or of one and the same given vehicle model at one or more given constant speeds on one or more roads or road segments associated with known international roughness index values or known road profiles;
collecting first vertical acceleration values, first vehicle geo-referencing data, and first vehicle speed data related to the given vehicle type and/or model; and
determining one or more vehicle transfer functions specific to the given vehicle type and/or model.

26. The system of claim 23, wherein the preliminary stage comprises:
driving one or more motor vehicles of different given vehicle types and/or of different given vehicle models at one or more given constant speeds on one or more roads or road segments associated with known international roughness index values or known road profiles;
collecting respective first vehicle vertical acceleration values, respective first vehicle geo-referencing data, and respective first vehicle speed data for each of the given vehicle types and/or models; and
for each of the given vehicle types and/or models, determining one or more respective vehicle transfer functions specific thereto;
wherein, in the international roughness index estimation stage, the international roughness index value is estimated by using at least one vehicle transfer function specific to vehicle type/model of the given motor vehicle determined in the preliminary stage.

27. The system of claim 23, wherein in the preliminary stage:
one or more average values of the first root mean square values are computed; and
the one or more vehicle transfer functions are determined based on the one or more computed average values.
